(19) United States
(12) Patent Application Publication
(10) Pub. No.: US 2003/0026294 A1
(43) Pub. Date: Feb. 6, 2003

(54) Subscribers-switching device and method of asymmetrical digital subscriber lines

(76) Inventor: Chul-Hee Lee, Sungnam-city (KR)

Correspondence Address: Robert E. Bushnell, Suite 300, 1522 K Street, N.W., Washington, DC, 20005, US

(21) Appl. No.: 10/180,453

(22) Filed: Jun. 27, 2002

(30) Foreign Application Priority Data
Jul. 20, 2001 (KR) 2001-43897
Jan. 10, 2002 (KR) 2002-1499

(51) Int. Cl. H04J 1/00

(52) U.S. Cl. 370/485; 375/222

(57) ABSTRACT

The present invention includes a subscriber-switching device and method in a system of asymmetrical digital subscriber lines ADSL. The subscriber-switching device includes multiple subscriber units including multiple subscriber ports, respectively; a redundancy subscriber unit including multiple subscriber ports, a network unit for transmitting data inputted from the multiple subscriber units to networks, a rear unit on a back plane of a shelf for transmitting data inputted from at least more than one of the subscriber lines to the subscriber unit, a common line board for connecting the subscriber lines of the rear unit to the redundancy subscriber unit through the common line, a switching means for switching among the subscriber port of the subscriber unit, the redundancy subscriber unit, and the common line board, and a controller for controlling mutual operation flows among the above units and means.

Therefore, data inputted from the subscriber line is continuously serviced to the subscribers through the switched redundancy subscriber unit without data interruption. As a result, the reliability of the transmitting device and the quality of the services can be improved enormously.

### CLAIM OF PRIORITY

This application makes reference to, incorporates the same herein, and claims all benefits accruing under 35 U.S.C. §119 from applications for SUBSCRIBERS-SWITCHING DEVICE AND METHOD OF ASYMMETRICAL DIGITAL SUBSCRIBER LINES earlier filed in the Korean Industrial Property Office on July 20, 2001 and there duly assigned Serial No. 2001-43897, and for SUBSCRIBERS-SWITCHING DEVICE AND METHOD OF ASYMMETRICAL DIGITAL SUBSCRIBER LINES earlier filed in the Korean Industrial Property Office on Jan. 10, 2002 and there duly assigned Serial No. 2002-1499.

### BACKGROUND OF THE INVENTION

1. Field of the Invention

The present invention refers to a subscribers-switching device and method of asymmetrical digital subscriber lines (i.e., “ADSL”), and more particularly, to a subscribers-switching device and method of the ADSL for providing subscribers for non-interrupting services without exchanging a defective subscriber unit or subscriber port when the subscriber unit or the subscriber port has a defect or trouble.

2. Description of the Related Art

Generally, a subscriber transmitting system includes multiple subscriber units, wherein each of the subscriber units in a shelf includes eight subscriber ports. Therefore, the entire subscriber units of the conventional subscriber transmitting system have to be exchanged when one of the subscriber ports of the subscriber unit has a defect or trouble in transmitting data.

Because the subscriber unit equips less than eight subscriber ports, other subscriber ports are not severely influenced when the subscriber unit having the defective subscriber port is replaced with a new subscriber unit.

However, the number of the subscribers has been increased in the case of the ADSL system in these days. Therefore, the subscriber unit in a shelf is made to have a large capacity, and the number of the subscriber ports in each of the subscriber units in the shelf has been increased.

Therefore, in the case of the ADSL system, the increase of the number of the subscriber ports in each of the subscriber units makes it difficult to exchange a defective or troubled subscriber port while the ADSL system services data to the subscribers.

In other words, to repair one of the defective or the troubled subscriber ports, the entire services to the multiple subscriber ports have to be interrupted. Therefore, the only one troubled subscriber port makes it impossible for the ADSL system to service data to the other normal subscriber ports.

In addition, in the case of the ADSL system, there is no available subscriber unit because of the increase of the number of the subscriber ports within the subscriber unit. However, the subscriber unit having the defective or troubled port has to be exchanged to provide the subscriber connected to the defective or troubled port for a normal service. Therefore, the ADSL system has to interrupt the service to the other subscriber ports to exchange the subscriber unit having the defective or troubled port. As a result, the conventional ADSL system cannot provide services for the subscribers continuously.

### SUMMARY OF THE INVENTION

It is, therefore, an object of the present invention provide a subscriber-switching device and method of an ADSL system switching a defective or troubled subscriber port and subscriber unit to other normal subscriber port and subscriber unit, respectively, so that non-interrupted data services to the subscribers can be supplied.

It is another object to provide a subscriber-switching apparatus and method of an ADSL system that is easy to manufacture and implement.

It is yet another object to provide a subscriber-switching apparatus and method of an ADSL system that improves the reliability and quality of the data services to the subscribers.

To accomplish the above and other objects, the present invention discloses a subscriber-switching device in a system of asymmetrical digital subscriber lines (i.e., “ADSL”) including: multiple subscriber units including multiple subscriber ports, respectively; a redundancy subscriber unit including multiple subscriber ports; a network unit for transmitting data inputted from the multiple subscriber units to the networks; a rear unit on a back plane of a shelf for transmitting data inputted from at least more than one of the subscriber lines to the subscriber unit; a common line board for connecting the subscriber lines of the rear unit to the redundancy subscriber unit through the common line; a switching means for switching among the subscriber port of the subscriber unit, the redundancy subscriber unit, and the common line board; and a controller for controlling mutual operation flows among the above units and means.

In addition, a middle portion of the one side of the rear unit includes an inserter inserted into the common line board, and the common line board includes a protruded connector for connecting the inserter.

In addition, each of the protruded connectors, on the common line board, is apart from each other in a predetermined distance, while the common line board is jointed to the back plane of the shelf by bolts.

In addition, the switching means includes at least more than one relay in the inside of the rear unit.

In addition, the switching means is in the inside of the rear unit.

In addition, the switching means includes at least more than one input relay for switching the corresponding subscriber ports, and at least more than one output relay for switching the common line board.

In addition, each of the subscriber units further includes a detector for detecting defects or troubles in the subscriber ports.

In addition, the shelf houses the multiple subscriber units, the redundancy subscriber unit, the network unit and the controller.

To accomplish other purposes, the present invention discloses the subscriber-switching method including the steps of: detecting defects or troubles in one of the multiple subscriber ports via the detector of the subscriber unit; controlling the switching means of the rear unit to disconnect the input relay of the corresponding subscriber ports, when the detector detects defects or troubles; driving the output relay of the corresponding ports of the subscriber unit to be connected to the corresponding common line of the common line board; and driving the output relay corresponding to the ports of the subscriber unit of the rear unit in the redundancy subscriber unit, and connecting the ports of the redundancy subscriber unit to the common line board, while a subscriber-switching device includes multiple subscriber units including multiple subscriber ports and detector for detecting defects or troubles among the multiple subscriber ports, respectively, a redundancy subscriber unit including multiple subscriber ports, a network unit for transmitting data inputted from the multiple subscriber units to networks, a rear unit on a back plane of a shelf for transmitting data inputted from at least one of the subscriber lines to the subscriber unit, a common line board for connecting the subscriber lines of the rear unit to the redundancy subscriber unit through the common line, a switching means including an input relay for switching subscriber ports of the multiple subscriber units and of the redundancy subscriber unit to the rear unit and an output relay for switching the rear unit to the common board, and a controller for controlling mutual operating flows in the subscriber switching device.

To accomplish other purposes, the present invention discloses the subscriber-switching method including the steps of detecting defects or troubles in the multiple subscriber ports via the detector of the subscriber unit; controlling the switching means of the rear unit to disconnect the entire input relays of the corresponding subscriber unit, when the detector detects defects or troubles; driving the output relay of the corresponding ports of the subscriber unit to be connected to the corresponding common line of the common line board; and driving the output relay corresponding to the ports of the subscriber unit of the rear unit in the redundancy subscriber unit, and connecting the ports of the redundancy subscriber unit to the common line board, while a subscriber-switching device includes multiple subscriber units including multiple subscriber ports and detector for detecting defects or troubles among the multiple subscriber ports, respectively, a redundancy subscriber unit including multiple subscriber ports, a network unit for transmitting data inputted from the multiple subscriber units to networks, a rear unit on a back plane of a shelf for transmitting data inputted from at least one of the subscriber lines to the subscriber unit, a common line board for connecting the subscriber lines of the rear unit to the redundancy subscriber unit through the common line, a switching means including an input relay for switching subscriber ports of the multiple subscriber units and of the redundancy subscriber unit to the rear unit and an output relay for switching the rear unit to the common board, and a controller for controlling mutual operating flows in the switching device.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view of a subscriber-switching device in asymmetrical digital subscriber lines (i.e., “ADSL”) according to a preferred embodiment of the present invention;

FIG. 2 is a block diagram illustrating a configuration of the subscriber-switching device in the ADSL according to the preferred embodiment of the present invention;

FIG. 3 is a circuit diagram illustrating a configuration of the subscriber-switching device in the ADSL according to the preferred embodiment of the present invention;

FIG. 4 is a circuit diagram switching a second port of the subscriber port of a subscriber unit in the subscriber-switching device in the ADSL according to the preferred embodiment of the present invention;

FIG. 5 is a flow chart illustrating a subscriber-switching method by utilizing a subscriber-switching device of FIG. 4;

FIG. 6 is a circuit diagram switching the entire subscriber unit of the subscriber-switching device in the ADSL according to the preferred embodiment of the present invention; and

FIG. 7 is a flow chart illustrating a subscriber-switching method by utilizing a subscriber-switching device of FIG. 6.

### DETAILED DESCRIPTION OF PREFERRED EMBODIMENTS

Reference will now be made in detail to preferred embodiments of the present invention, example of which is illustrated in the accompanying drawings.

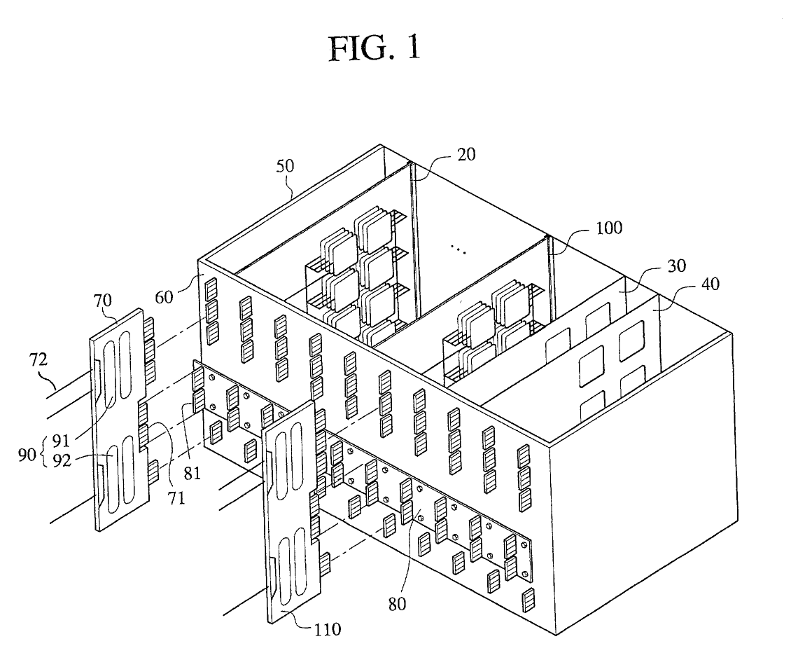

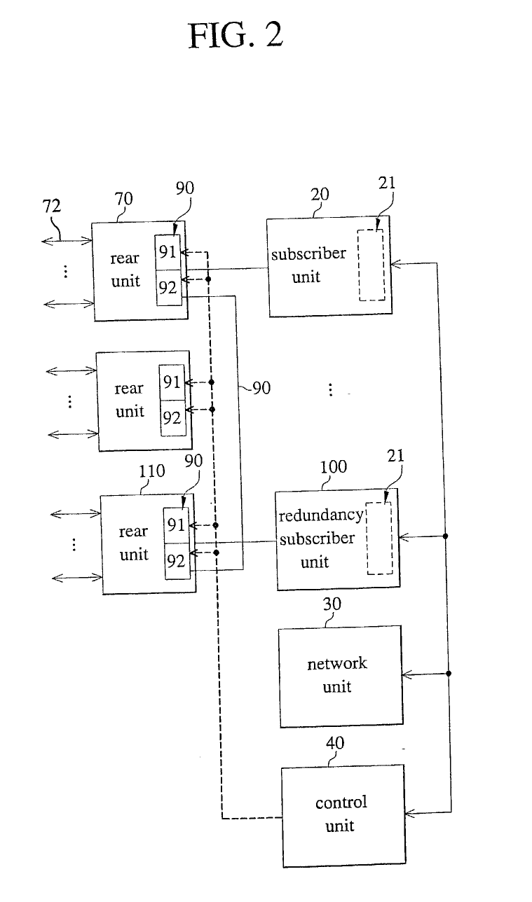

FIG. 1 is a perspective view of a subscriber-switching device in asymmetrical digital subscriber lines (i.e., “ADSL”) according to the preferred embodiment of the present invention, and FIG. 2 is a block diagram illustrating a configuration of the subscriber-switching device in the ADSL according to the preferred embodiment of the present invention.

The subscriber-switching device in the ADSL system according to the present invention includes a subscriber unit 20, a redundancy subscriber unit 100, a network unit 30, a shelf 50, rear units 70 and 110, and a common line board 80, wherein each of the rear units 70 includes a switching means (or unit) 90.

In more detail, each of the subscriber units 20 connected to the rear unit 70 includes multiple subscriber ports 10, and the redundancy subscriber unit 100 switches a defective or troubled subscriber unit and subscriber port of the subscriber unit 20. Additionally, the network unit 30 transmits data inputted from the subscriber unit 20 to the networks, and the shelf 50 includes a controller 40 for controlling the subscriber unit 20 and the network unit 30.

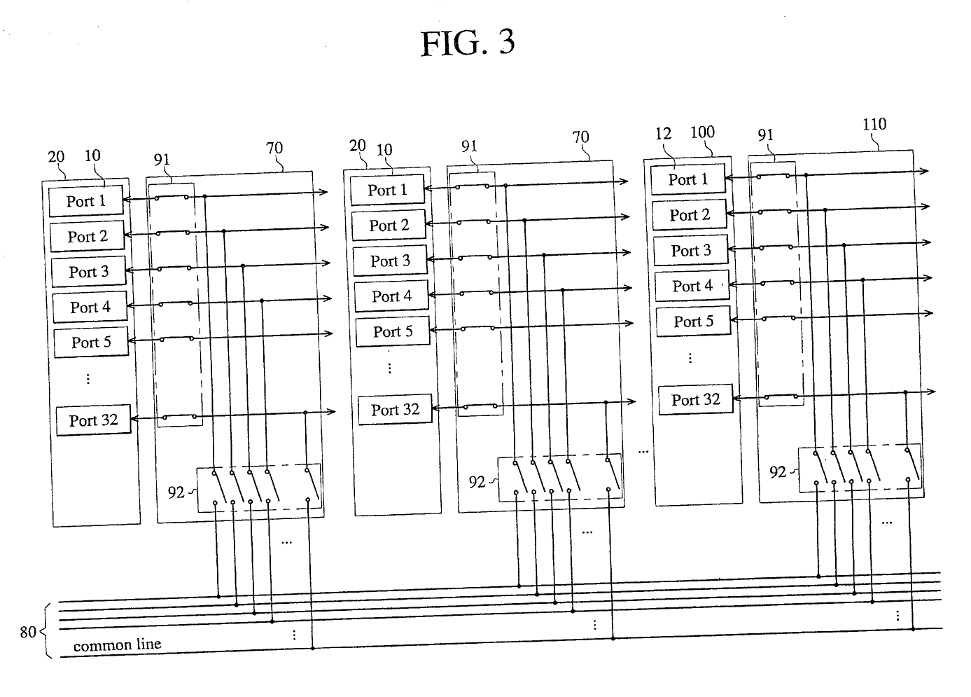

In addition, the rear units 70 and 110 connect multiple subscriber lines 72 to the subscriber unit 20 and the redundancy subscriber unit 100, including the subscriber ports 10 and 12, respectively, of a back plane 60 in the shelf 50. In addition, a common line board 80 connects the rear unit 70 of the subscriber unit 20 to the rear unit 110 of the redundancy subscriber unit 100 through the common line (shown in FIG. 3). In addition, the switching means (or unit) 90 switches among the subscriber unit 20, the redundancy subscriber unit 100, and the common line board 80.

In addition, an inserter 71 included in the middle of the one side of the rear unit 70 is connected to the common line of the common line board 80, and the common line board 80 includes the protruded connectors 81 connected to the inserter 71.

In addition, each of the protruded connectors 81, on the common line board 80, is apart from each other in a predetermined distance, while the common line board 80 is jointed to the back plane of the shelf by bolts. In addition, the switching means 90 in the inside of the rear unit 70 includes relays, wherein the one relay is an input relay 91 for switching the subscriber port 10 of the subscriber unit 20, and the other relay is an output relay 92 for switching the common line board 80.

In addition, the detector 21 detects a defective or troubled port of the subscriber ports within the subscriber unit 20 including the redundancy subscriber unit 100 as seen in FIG. 2.

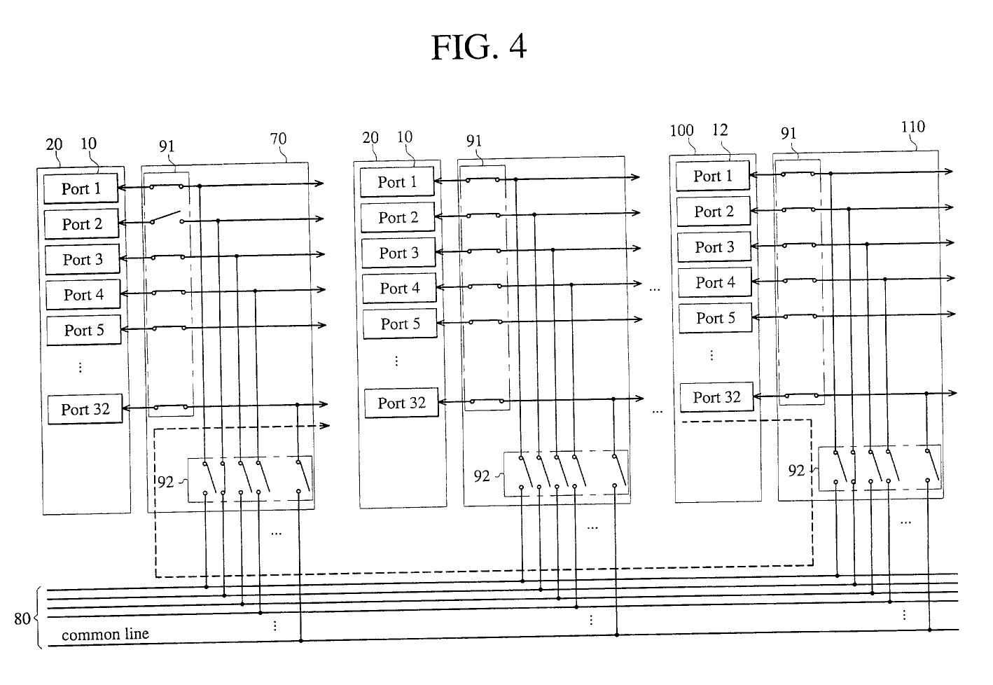

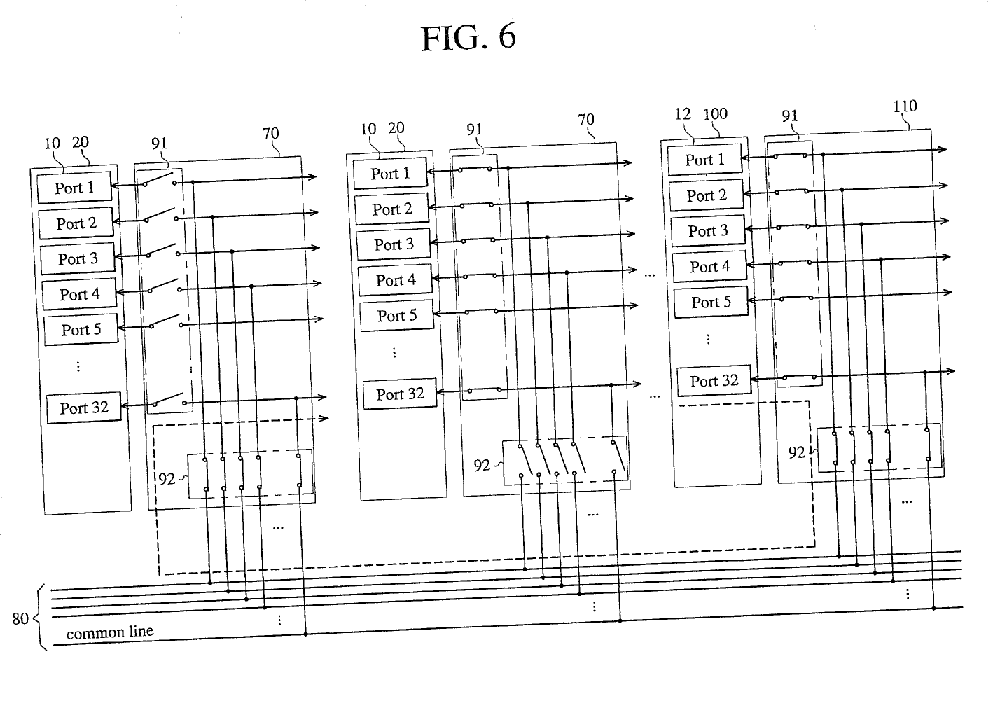

Referring to FIG. 3, FIG. 4 and FIG. 6, the rear units 70 and 110 are connected to the multiple subscriber units 20 and the redundancy subscriber unit 100 in the shelf 50, respectively, to transmit data inputted from the multiple subscriber lines 72, and output the transmitted data to the multiple subscriber lines 72 again. Additionally, each of the rear units 70 and 110 of the subscriber units 20 and of the redundancy subscriber unit 100, respectively includes the switching means 90 including the input relay 91 and the output relay 92. The input relay 91 switches data inputted to the subscriber port 10 of the multiple subscriber units 20 from the multiple subscriber lines 72, and the output relay 92 switches from the multiple subscriber lines 72 to the common line board 80.

Therefore, the subscriber-switching device according to the present invention includes the shelf 50, and the rear units 70 and 110. In this case, the shelf 50 includes the subscriber unit 20 including multiple subscriber ports 10, the redundancy subscriber unit 100 including multiple subscriber ports 12, the network unit 30, the controller 40, and the common line board 80 including the protruded connector 81 on the back plane 60 of the shelf 50. Additionally, the shelf 50 is connected to the rear units 70 and 110 including the switching means 90.

The inserter 71 in the rear units 70 connected to the subscriber unit 20, and the inserter 71 in the rear units 110 connected to the redundancy subscriber unit 100 through the common line board 80, are inserted into corresponding protruded connectors 81 of the common line board 80.

FIG. 3 is a circuit diagram illustrating a configuration of the subscriber-switching device in the ADSL according to the preferred embodiment of the present invention. When the subscriber unit 20 and the redundancy subscriber unit 100 are connected to the corresponding rear unit 70 and 110 through the common line board 80 as shown in FIG. 3, data inputted from the multiple subscriber lines 72 of the rear unit 70 are transmitted to the controller 40 through the subscriber ports 10 of the subscriber unit 20, and the controller 40 transmits the transmitted data through the network unit 30.

Therefore, the network unit 30 transmits the data to the network (not shown) so that data services between numerous subscribers are performed.

When the data services between numerous subscribers are performed, the input relay 91 of the switching means 90 within the rear unit 70 is connected to the subscriber unit 20, and the output relay 92 of the switching unit 90 is disconnected from the common line of the common line board 80 in reverse.

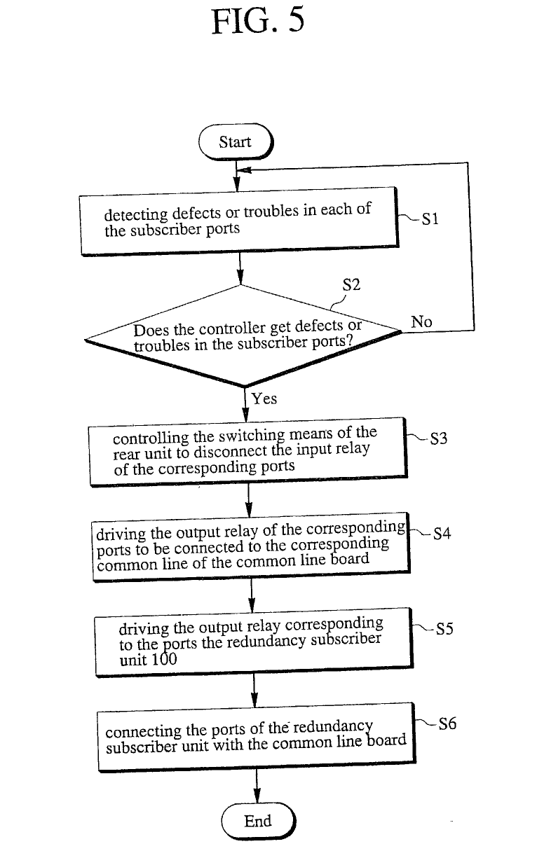

On the contrary, when one of the multiple subscriber ports 10 of the subscriber unit 20 gets defects or troubles, the corresponding port of the redundancy subscriber unit 100 is switched. For example, FIG. 4 is a circuit diagram switching a second port of the subscriber port of a subscriber unit in the subscriber-switching device in the ADSL according to the preferred embodiment of the present invention, and FIG. 5 is a flow chart illustrating a subscriber-switching method by utilizing a subscriber-switching device.

The controller 40 detects defects or troubles in the one of the subscriber ports 10 or of the subscriber units 20 via the detector 21 of the subscriber unit 20 during data services (step S1).

As shown in FIG. 4, the second port of the subscriber port 10 is supposed to be in defects or troubles. In this case, the controller 40 detects defects or troubles in the second port of the subscriber port 10 of the subscriber unit 20 (step S2). Therefore, the controller 40 controls the switching means 90 of the rear unit 70 to disconnect the input relay 91 of the corresponding second port of the subscriber port 10 (step S3). Additionally, the controller 40 drives the output relay 92 of the corresponding second port of the subscriber port 10 to be connected to the corresponding common line of the common line board 80 (step S4).

In addition, the controller 40 drives the output relay 92 corresponding to the second port of the subscriber ports 12 of the rear unit 110 in the redundancy subscriber unit 100 (step S5), and connects the second port 12 of the redundancy subscriber unit 100 to the common line board 80 (step S6).

Therefore, the defective or the troubled second port of the subscriber ports 10 of the subscriber unit 20 is connected to the second port of the subscriber port 12 of the redundancy subscriber unit 100 via the corresponding common line of the common line board 80 and the output relays 92 of each of the rear units 70 and 110. As a result, the data can be transmitted through the subscriber port 12 of the redundancy subscriber unit 100.

On the contrary, when most of the subscriber ports 10 in the subscriber unit 20 gets defects or troubles, the entire subscriber unit 20 can be switched instead of switching one of the subscriber ports 10 in the subscriber unit 20.

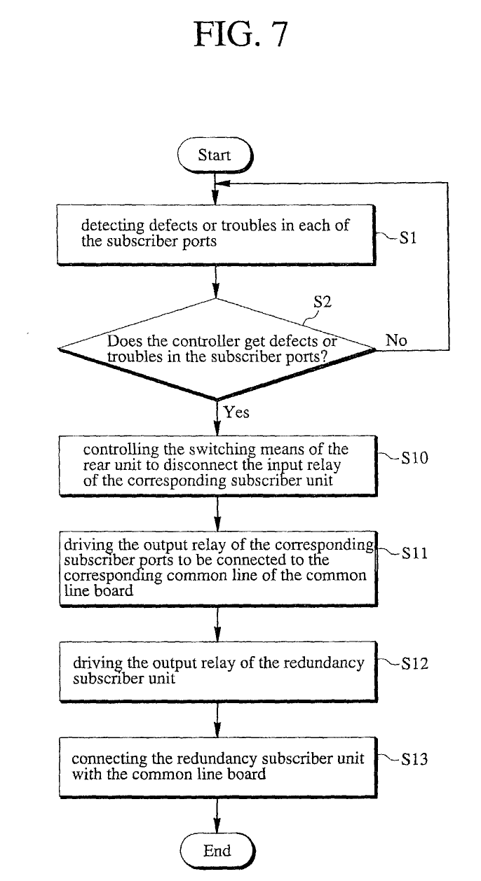

As illustrated in the above statement, FIG. 6 illustrates a method of switching the entire defective or troubled subscriber unit 20. In other words, FIG. 6 is a circuit diagram switching the entire troubled subscriber unit 20 of the subscriber-switching device in the ADSL to the redundancy subscriber unit 100, and FIG. 7 is a flow chart of such a subscriber-switching method.

Referring to FIG. 6, the input relay 91 of the switching means 90 installed in the rear unit 70 is cut off to disconnect the entire subscriber ports 10 of the subscriber unit 20 (step S10). Sequentially, the output relay 92 of the switching means 90 is entirely operated to be connected to the entire common lines of the common line board 80 (step S11).

In addition, the output relay 92 of the rear unit 110 of the redundancy subscriber unit 100 are entirely driven (step S12), and connected to the entire common lines of the common line board 80, so that the defective and troubled subscriber unit 20 is entirely switched into the redundancy subscriber unit 100 (step S13).

Therefore, non-interrupted data services are performed even though the subscriber port 10 of the subscriber unit 20 has a defect or a trouble.

As described in the above statements, the preferred embodiments of the present invention includes a subscriber unit, a redundancy subscriber unit, and a rear unit. The subscriber unit and the redundancy subscriber unit include multiple subscriber ports in a shelf, respectively, and the rear units of the subscriber unit and of the redundancy subscriber unit include a switching means for connecting multiple subscriber lines to the subscriber ports of the subscriber unit. When one of the multiple subscriber ports of the subscriber unit has a defect or trouble, the defective or troubled subscriber port or the subscriber unit is switched to the subscriber ports of the redundancy subscriber unit or to the redundancy subscriber unit through the switching means. Therefore, data inputted from the subscriber line is continuously serviced to the subscribers through the switched redundancy subscriber unit without data interruption. As a result, the reliability of the transmitting device and the quality of the services can be improved enormously.

While the invention has been particularly shown and described with reference to preferred embodiments thereof, it will be understood by those skilled in the art that the foregoing and other changes in form and details maybe made therein without departing from the spirit and scope of the invention.

What is claimed is:

1. A subscriber-switching device in a system of asymmetrical digital subscriber lines, comprising:
a plurality of subscriber units with each one of said plurality of subscriber units including a plurality of subscriber ports, said plurality of subscriber units comprising at least a first subscriber unit and a redundancy subscriber unit;
a network unit transmitting data inputted from said plurality of subscriber units to at least one network;
a rear unit on a back plane of a shelf for transmitting data inputted from at least one of the subscriber lines to a corresponding one of said plurality of subscriber units;
a common line board for connecting the subscriber lines of said rear unit to said redundancy subscriber unit through said common line;
a switching means for switching among the subscriber ports of said first subscriber unit, said redundancy subscriber unit, and said common line board; and
a controller for controlling mutual operating flows among said plurality of subscriber units including said redundancy subscriber unit, said network unit, said rear unit, said common line board, and said switching means.

2. The subscriber-switching device according to claim 1, with a middle portion of the one side of said rear unit comprising an inserter inserted into said common line board, and said common line board comprising a protruded connector for connecting to said inserter.

3. The subscriber-switching device according to claim 2, with each of the protruded connectors, on said common line board, being apart from each other in a predetermined distance, while said common line board is jointed to the back plane of said shelf by bolts.

4. The subscriber-switching device according to claim 1, with said switching means comprising at least one relay in the inside of said rear unit.

5. The subscriber-switching device according to claim 1, with said switching means being in the inside of said rear unit.

6. The subscriber-switching device according to claim 1, said switching means comprising at least one input relay for switching the corresponding subscriber ports, and at least one output relay for switching said common line board.

7. The subscriber-switching device according to claim 1, with each of said subscriber units further including a detector for detecting defects or troubles in the subscriber ports.

8. The subscriber-switching device according to claim 1, said shelf housing said plurality of subscriber units including said first subscriber unit and said redundancy subscriber unit, said network unit and said controller.

9. The subscriber-switching device according to claim 1, said switching means comprising at least one input relay switching data inputted to the corresponding subscriber ports from the plurality of subscriber lines, and at least one output relay switching from the plurality of subscriber lines to said common line board.

10. A subscriber-switching method of a subscriber-switching device comprising a plurality of subscriber units with each one of the subscriber units including a plurality of subscriber ports and detector for detecting defects or troubles among the plurality of subscriber ports, a redundancy subscriber unit including a plurality of subscriber ports, a network unit for transmitting data inputted from the plurality of subscriber units to networks, a rear unit on a back plane of a shelf for transmitting data inputted from at least one of the subscriber lines to one of the subscriber units, a common line board for connecting the subscriber lines of the rear unit to the redundancy subscriber unit through the common line, a switching means comprising an input relay for switching the subscriber ports of the plurality of subscriber units and of the redundancy subscriber unit to the rear unit and an output relay for switching the rear unit to the common board, and a controller for controlling mutual operating flows in the subscriber device, the method comprising steps of:
detecting defects or troubles in one of the plurality of subscriber ports via the detector of one of the subscriber units;
controlling the switching means of the rear unit to disconnect the input relay of the corresponding subscriber ports, when the detector detects defects or troubles;
driving the output relay of the corresponding ports of the subscriber unit to be connected to the corresponding common line of the common line board; and
driving the output relay corresponding to the ports of the subscriber unit of the rear unit in the redundancy subscriber unit, and connecting the ports of the redundancy subscriber unit to the common line board.

11. A subscriber-switching method of a subscriber-switching device comprising a plurality of subscriber units including a plurality of subscriber ports and detector for detecting defects or troubles among the multiple subscriber ports, respectively, a redundancy subscriber unit including a plurality of subscriber ports, a network unit for transmitting data inputted from the plurality of subscriber units to networks, a rear unit on a back plane of a shelf for transmitting data inputted from at least one of the subscriber lines to the subscriber unit, a common line board for connecting the subscriber lines of the rear unit to the redundancy subscriber unit through the common line, a switching means comprising an input relay for switching subscriber ports of the plurality of subscriber units and of the redundancy subscriber unit to the rear unit and an output relay for switching the rear unit to the common board, and a controller for controlling mutual operation flows in the subscriber device, the method comprising steps of:
detecting defects or troubles in the plurality of subscriber ports via the detector of the subscriber unit;
controlling the switching means of the rear unit to disconnect the entire input relays of the corresponding subscriber unit, when the detector detects defects or troubles;
driving the output relay of the corresponding ports of the subscriber unit to be connected to the corresponding common line of the common line board; and
driving the output relay corresponding to the ports of the subscriber unit of the rear unit in the redundancy subscriber unit, and connecting the ports of the redundancy subscriber unit to the common line board.

12. A method, comprising:
detecting a malfunction in each one of a plurality of subscriber ports of each one of a plurality of subscriber units, each one of said plurality of subscriber units including said plurality of subscriber ports in a subscriber-switching device using subscriber lines;
determining a malfunction in at least one of said plurality of subscriber ports;
controlling a switching unit of a rear unit to disconnect an input switch of the malfunctioning subscriber port, said rear unit included on a back plane of a shelf for transmitting data inputted from the subscriber lines to the subscriber units, said switching unit for switching among the subscriber ports of the subscriber units, said input switch included in said switching unit in the rear unit to switch the corresponding subscriber ports;
driving an output switch of the corresponding malfunctioning subscriber port to be connected to a corresponding common line of a common line board, said output switch included in said switching unit and for switching said common line board, said common line board connecting said subscriber lines of said rear unit to a redundancy subscriber unit through said common line, said redundancy subscriber unit included in said plurality of subscriber units;
driving a second output switch corresponding to the port of said redundancy subscriber unit, the port of said redundancy subscriber unit corresponding to the malfunctioning port of the subscriber unit; and
connecting the port of said redundancy subscriber unit with said common line board.

13. The method according to claim 12, after said act of determining a malfunction in at least one of said plurality of subscriber ports, when a certain amount of subscriber ports in a certain subscriber unit are malfunctioning, said method further comprising:
controlling a switching unit of a rear unit to disconnect all input switches of the malfunctioning subscriber unit;
driving all output switches of the corresponding malfunctioning port to be connected to a corresponding common line of a common line board, said output switch included in said switching unit and for switching said common line board, said common line board connecting said subscriber lines of said rear unit to a redundancy subscriber unit through said common line, said redundancy subscriber unit included in said plurality of subscriber units;
driving all second output switches corresponding to the ports of said redundancy subscriber unit; and
connecting all ports of said redundancy subscriber unit with said common line board.

14. The method according to claim 13, with the act of detecting the malfunctions being made by a detector in each of the subscriber units.

15. An apparatus, comprising:
a plurality of subscriber units with each one of said plurality of subscriber units including a plurality of subscriber ports, said plurality of subscriber units comprising at least a first subscriber unit and a redundancy subscriber unit;
a common line board for connecting subscriber lines to said redundancy subscriber unit through said common line;
a switching unit for switching among the subscriber port of said first subscriber unit, said redundancy subscriber unit, and said common line board; and
a controller for controlling mutual operating flows among said plurality of subscriber units including said redundancy subscriber unit, said rear unit, said common line board, and said switching unit.

16. The apparatus according to claim 15, further comprising a network unit transmitting data inputted from said plurality of subscriber units to at least one network.

17. The apparatus according to claim 15, further comprising a rear unit on a back plane of a shelf for transmitting data inputted from the subscriber lines to a corresponding one of said plurality of subscriber units.

18. The apparatus according to claim 17, said subscriber lines being digital subscriber lines.

19. The apparatus according to claim 18, with a middle portion of the one side of said rear unit comprising an inserter inserted into said common line board, and said common line board comprising a protruded connector for connecting to said inserter.

20. The apparatus according to claim 19, with each of the protruded connectors, on said common line board, being apart from each other in a predetermined distance, while said common line board is jointed to the back plane of said shelf by bolts.

21. The apparatus according to claim 20, with said switching unit comprising at least one relay in the inside of said rear unit.

22. The apparatus according to claim 20, with said switching unit being in the inside of said rear unit.

23. The apparatus according to claim 22, said switching unit comprising at least one input switch for switching the corresponding subscriber ports, and at least one output switch for switching said common line board.

24. The apparatus according to claim 23, with each of said subscriber units further comprising a detector for detecting defects or troubles in the subscriber ports.

25. The apparatus according to claim 24, said shelf housing said plurality of subscriber units including said first subscriber unit and said redundancy subscriber unit, and said controller.
